(19) United States
(12) Patent Application Publication
(10) Pub. No.: US 2010/0252201 A1
(43) Pub. Date: Oct. 7, 2010

(54) LABELING MACHINE FOR LABELS PRINTED ON CONTINUOUS FILM

(75) Inventor: Mario Ballarotti, Marmirolo (IT)

Correspondence Address: GREER, BURNS & CRAIN, 300 S WACKER DR, 25TH FLOOR, CHICAGO, IL, 60606, US

(73) Assignee: P.E. LABELLERS S.P.A., Porto Mantovano (IT)

(21) Appl. No.: 12/742,132

(22) PCT Filed: Oct. 22, 2008
(86) PCT No.: PCT/EP2008/064260

§ 371 Date: May 10, 2010

(30) Foreign Application Priority Data
Nov. 30, 2007 (IT) MN2007A000043

(51) Int. Cl. B65C 9/42

(52) U.S. Cl. 156/361

(57) ABSTRACT

A labeling machine for labels printed on continuous film, comprising, in an intermediate position between a motorized reel and a feed roller, a tunnel provided with suction elements adapted to determine on the film in transit inside it an attraction that gives it a bent configuration, elements being provided which are adapted to control the depth of the bend, the tunnel being provided with a bottom and a lid that are adapted to align the film at a constant height.

### TECHNICAL FIELD

The present invention relates to a labeling machine for labels printed on continuous film.

### BACKGROUND ART

It is known that there are labeling machines designed to process labels printed on a continuous film that is unwound from a motorized reel, and that said film can be pre-pasted, i.e., provided with paste, at one face, or not, and in this case suitable pasting means are provided within the machine.

Such labeling machines comprise a drum that accompanies the film, retaining it so that it adheres to the surface by way of suction generated at the surface, cutting the individual labels up to being applied to corresponding containers conveyed by conveyance means, which are commonly constituted by a rotating carousel.

The film of the labels is fed to the drum by means of a feed roller, which, in order to be able to work correctly at the high speeds currently required, needs to receive the film unwound from the reel in extremely low and constant tension conditions, the film being further aligned at a constant height.

For this purpose, the background art provides for the presence of tensioning devices combined with alignment devices, which however are not entirely satisfactory.

### DISCLOSURE OF THE INVENTION

Therefore the aim of the present invention is to provide a labeling machine in which the arrival of the film of the labels to the feed roller is ensured in such conditions as to ensure optimal operation of the roller.

The above aim and other objects which will become better apparent hereinafter are achieved by a labeling machine for labels printed on continuous film, according to the invention, comprising a feed roller that conveys the film of the labels from a motorized reel to a drum that accompanies the film, cutting the individual labels, up to being brought to application on corresponding containers supported by conveyance means, characterized by the presence, in a position comprised between said motorized reel and said feed roller, of a tunnel provided with suction means adapted to determine on the film in transit inside it an attraction that gives it a bent configuration, means being provided which are adapted to control the depth of said bend, and said tunnel being provided with a bottom and a lid that are adapted to align the film at a constant height.

### BRIEF DESCRIPTION OF THE DRAWINGS

Further characteristics and advantages of the present invention will become better apparent from the description of two preferred but not exclusive embodiments thereof, illustrated by way of non-limiting example in the accompanying drawings, wherein:

FIG. 1 is a schematic plan view of the labeling machine according to the invention;

FIG. 2 is a view of the detail of the tunnel;

FIG. 3 is a schematic plan view according to another embodiment of the labeling machine according to the invention.

### DESCRIPTION OF THE PREFERRED EMBODIMENTS

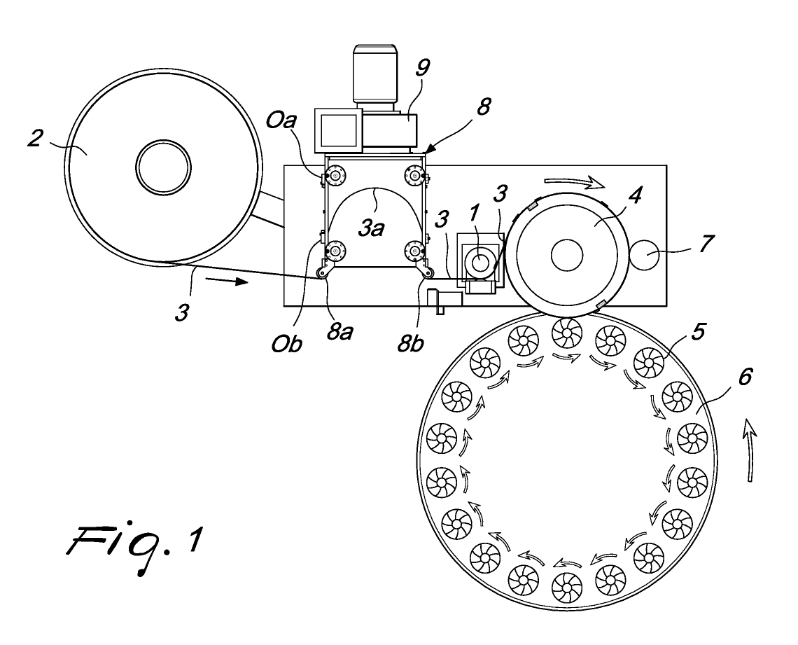

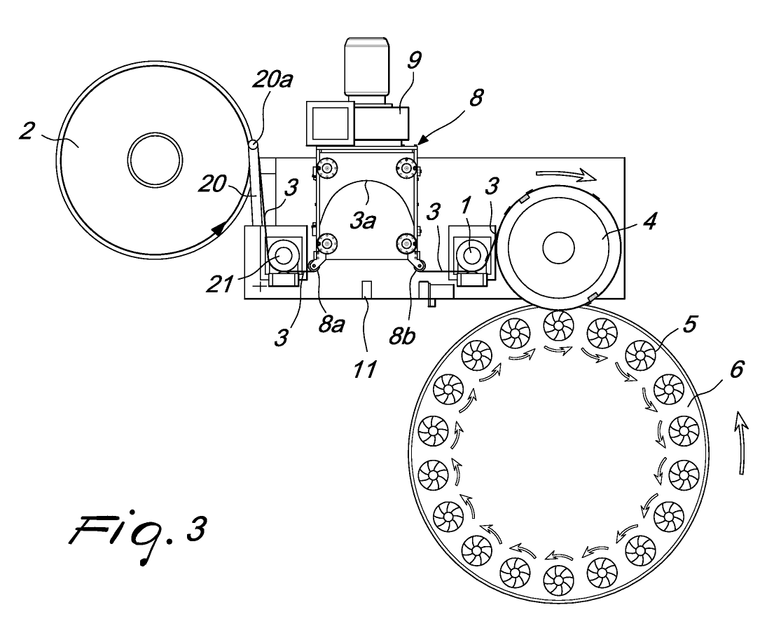

It should be specified that the embodiment shown in FIG. 1 is designed to process a film of labels that is not pre-pasted, while the embodiment of FIG. 3 is designed to process a pre-pasted film, and that both comprise a feed roller 1 that conveys from a motorized reel 2 the film of the labels 3 to a drum 4 that accompanies the film, cutting the individual labels up to being applied to individual containers 5 conveyed by a rotating carousel 6.

In the case of the machine of FIG. 1, which processes a film of labels that is not pre-pasted, means 7 for pasting the film 3 are provided, which obviously are absent in the case of the machine of FIG. 3, which processes pre-pasted films.

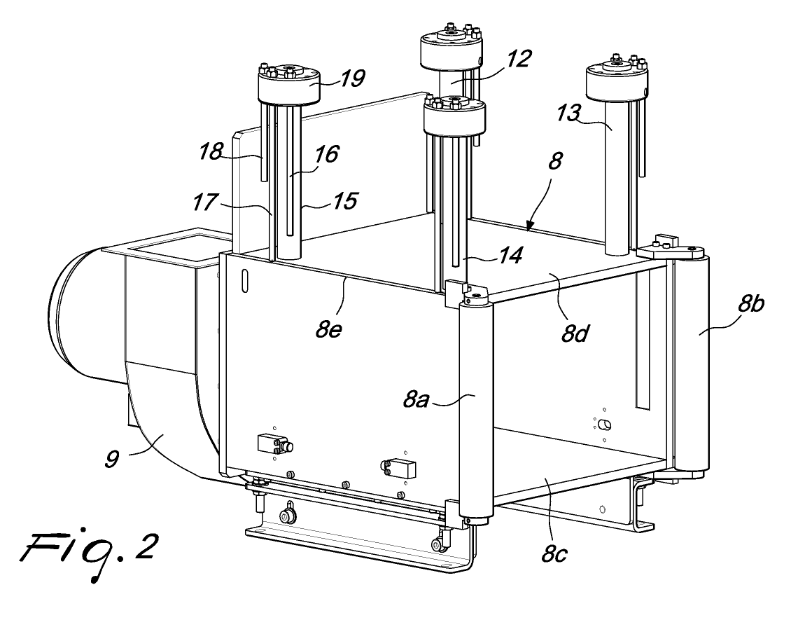

In both embodiments of FIGS. 1 and 3, in a position that directly precedes the feed roller 1, there is a tunnel, generally designated by the reference numeral 8, that is described in detail with particular reference to FIG. 2.

Tunnel 8 is provided with suction means, which comprise a fan 9 and are adapted to provide on the film of labels in transit within it, between the input roller 8a and the output roller 8b, an attraction that is such as to induce it to arrange itself along a bend 3a, whose depth is controlled by way of appropriate means that are adapted to send signals to the control electronics of the machine.

Such means comprise, in the embodiment of FIG. 1, two photocells 10a, 10b, which are conveniently spaced in the direction of the axis of symmetry of the loop, and instead comprise, in the embodiment of FIG. 3, only a photocell 11 located at the plane of symmetry of the loop; of course, the described means are interchangeable between the two embodiments.

The presence of the tunnel 8 according to the invention ensures occurrence of the condition in which the film of labels 3 reaches the feed roller 1 in the conditions of extremely low and constant tension that are required for optimum operation; moreover, the tunnel provides, by means of its bottom 8c and its lid 8d, a guide at the respectively lower and upper edges of the film 3 that ensures perfect alignment at a constant height.

In order to obtain such a flexibility of operation of the tunnel as to allow to change the format of the labels being processed, the lid 8d is provided with means that are adapted to determine the arrangement thereof at a variable height from the bottom 8c, without altering the fact that if the format change is not intended, the lid is at a fixed height.

Such means thus comprise four columns 12, 13, 14, 15, which are jointly connected to the lid 8d and are provided with identical equipment, and therefore only the column 15 will be described in detail.

The column 15 is provided with three rods 16, 17, 18 of different lengths, which are applied in an adjustable manner to a rotatable support 19, such rods being adapted to rest selectively at the end, as a consequence of the rotation of the support 19, on a fixed frame 8e of the lid 8d.

In the situation of FIG. 2, the longer rods 17, of the four columns rest on the frame 8e, and accordingly the lid 8d is at the highest level; to lower it for example by a first extent, it is sufficient to rotate the supports 19 and bring the intermediate-length rods 16 of the four columns to rest with the edge 8e, and a further lowering can be obtained by making the shorter rods 18 rest on such edge.

Whereas in the case of the machine of FIG. 1, designed to process a film that is not pre-pasted, the tunnel 8 is arranged directly adjacent to the reel 2, from which the film 3 unwinds, the machine of FIG. 3 that processes a pre-pasted film comprises means that are interposed between the reel 2 and the tunnel 8 and are adapted to facilitate removal of the film 3 from the reel in order to prepare it for the action of the tunnel.

Such means comprise an arm 20, in which the end provided with a roller 20a is retained, by elastic means not shown in the figure, in contact with the surface that is not pre-pasted of the film 3 in the region where the film begins to separate from the reel, and a takeup roller 21 acts on the film at the portion comprised between the arm 20 and the access to the tunnel 8.

The described invention is susceptible of numerous modifications and variations, all of which are within the scope of the appended claims; all the details may further be replaced with other technically equivalent elements.

The disclosures in Italian Patent Application No. MN2007A000043 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A labeling machine for labels printed on continuous film, comprising a feed roller that conveys the film of the labels from a motorized reel to a drum that accompanies the film, cutting the individual labels, up to being brought to application on corresponding containers supported by conveyance means, wherein a tunnel is provided in a position comprised between said motorized reel and said feed roller, said tunnel being provided with suction means adapted to determine on the film in transit inside it an attraction that gives it a bent configuration, means being provided which are adapted to control the depth of said loop, and said tunnel being provided with a bottom and a lid that are adapted to align the film at a constant height.

12. The machine according to claim 11, wherein the tunnel is provided with suction means that comprise a fan applied to the end wall of said tunnel.

13. The machine according to claim 11, wherein the tunnel is provided with means that are adapted to control the depth of a bend and comprise two photocells that are conveniently spaced in the direction of the axis of symmetry of the bend.

14. The machine according to claim 11, wherein the tunnel is provided with means that are adapted to control the depth of the bend and comprise a photocell located at the plane of symmetry of the bend.

15. The machine according to claim 11, wherein the lid of the tunnel is arranged at a fixed height from the bottom.

16. The machine according to claim 11, wherein the lid of the tunnel is provided with means that are adapted to position it at variable heights from the bottom.

17. The machine according to claim 11, wherein the lid of the tunnel is provided with means that are adapted to position it at variable heights from the bottom, comprising a plurality of columns that are jointly connected to the lid and are provided with rods of different lengths which are applied adjustably to a rotatable support that is located at the top of said columns, said rods being adapted to rest selectively at the end on a fixed frame of said lid.

18. The machine according to claim 11, designed to process labels printed on continuous film that is not pre-pasted, and comprising means for pasting said film, wherein the tunnel is arranged adjacent to the motorized reel of said film.

19. The machine according to claim 11, designed to process labels printed on pre-pasted continuous film, further comprising means that are interposed between the motorized reel of said film and the tunnel and are adapted to facilitate the takeup of said film from the reel so as to prepare it for the action of the tunnel.

20. The machine according to claim 11, designed to process labels printed on pre-pasted continuous film, further comprising means that are interposed between the motorized reel of said film and the tunnel and are adapted to facilitate the takeup of said film from the reel so as to prepare it for the action of the tunnel, said means comprising an arm which has a rounded end kept in contact with the non-pasted surface of the film in the region where said film begins to separate from the reel, and a takeup roller that acts on the film at the portion comprised between said arm and the access to the tunnel.
